(19) United States
(12) Patent Application Publication
(10) Pub. No.: US 2026/0256643 A1
(43) Pub. Date: Sep. 3, 2026

(54) MASSAGE DEVICE

(71) Applicant: Chirp Innovation, Inc., Lehi, UT (US)

(72) Inventors: Reeve Stewart Sudweeks, Lehi, UT (US); Brian Connolly Nielson, American Fork, UT (US); Weston N. Hills, Kamas, UT (US); Jason Lee Walton, Draper, UT (US); Caden-Thomas Atwood Wakefield, Edgewood, WA (US); Tate Sherman Stock, Draper, UT (US)

(21) Appl. No.: 19/467,497

(22) Filed: Feb. 2, 2026

Related U.S. Application Data
(63) Continuation of application No. 29/954,976, filed on Jul. 30, 2024, now Pat. No. D1111184.

(51) Int. Cl. A61H 19/00

(52) U.S. Cl. CPC A61H 19/00

(57) ABSTRACT

An ornamental design for a massage device.

### CROSS REFERENCE TO RELATED APPLICATION

The present application is a continuation of U.S. Design Application No. Ser. No. 29/954,976, filed Jul. 30, 2024, the entire disclosure of which is incorporated herein by reference and for all purposes.

### PREAMBLE

Be it known that we, Reeve Stewart Sudweeks, Brian Connolly Nielson, Weston N. Hills, Jason Lee Walton, Caden-Thomas Atwood Wakefield, and Tate Sherman Stock, have invented a new and ornamental design for a Massage Device, of which the following is a specification, reference being had to the accompanying drawings, which form a part hereof.

### DESCRIPTION

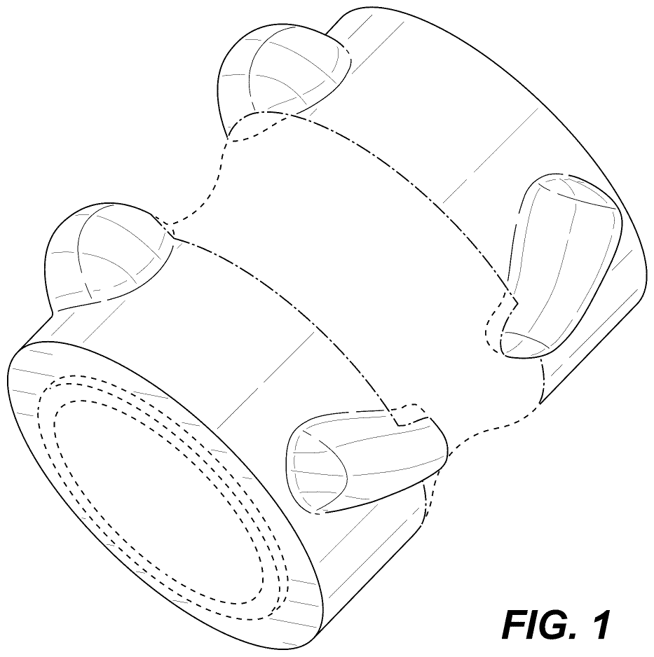

FIG. 1 is a back, left-side perspective view of a massage device;

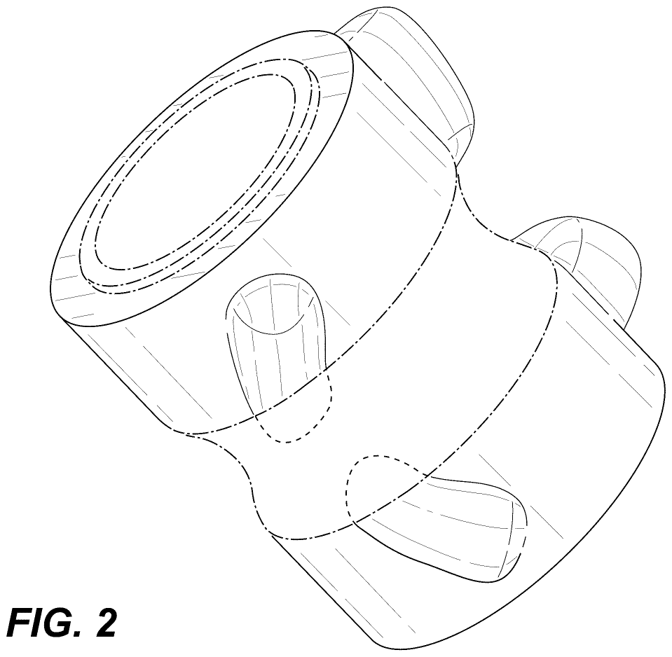

FIG. 2 is a bottom, right-side perspective view thereof;

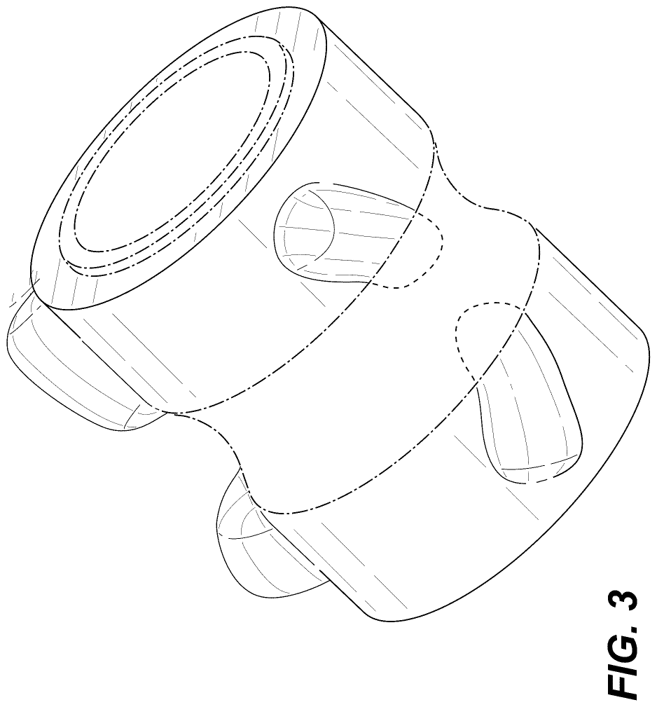

FIG. 3 is a bottom, left-side perspective view thereof;

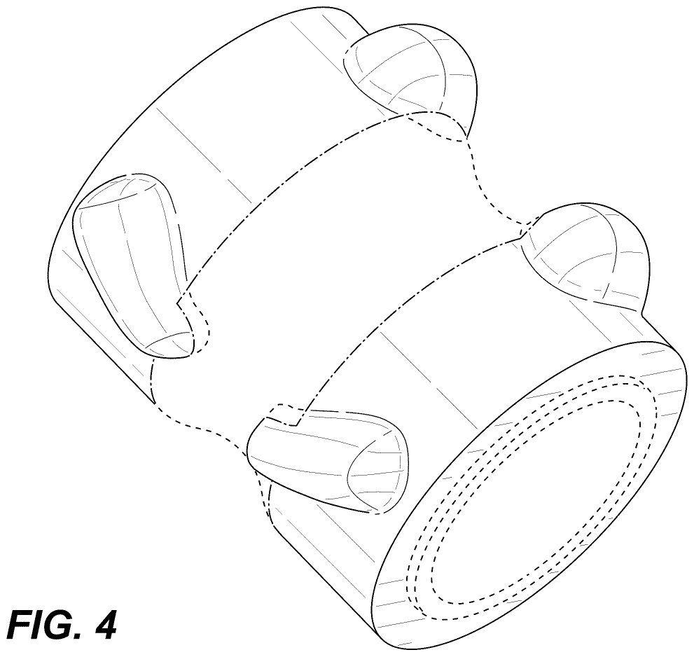

FIG. 4 is a back, right-side perspective view thereof;

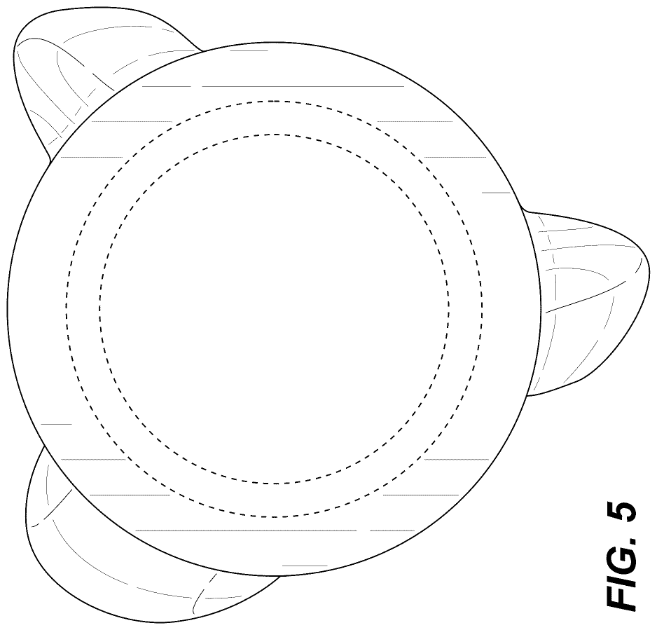

FIG. 5 is a left-side view thereof;

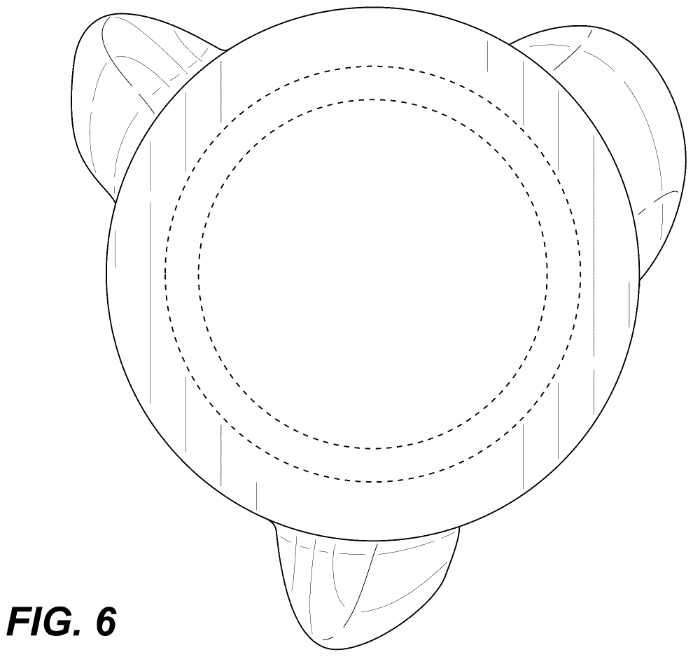

FIG. 6 is a right-side view thereof;

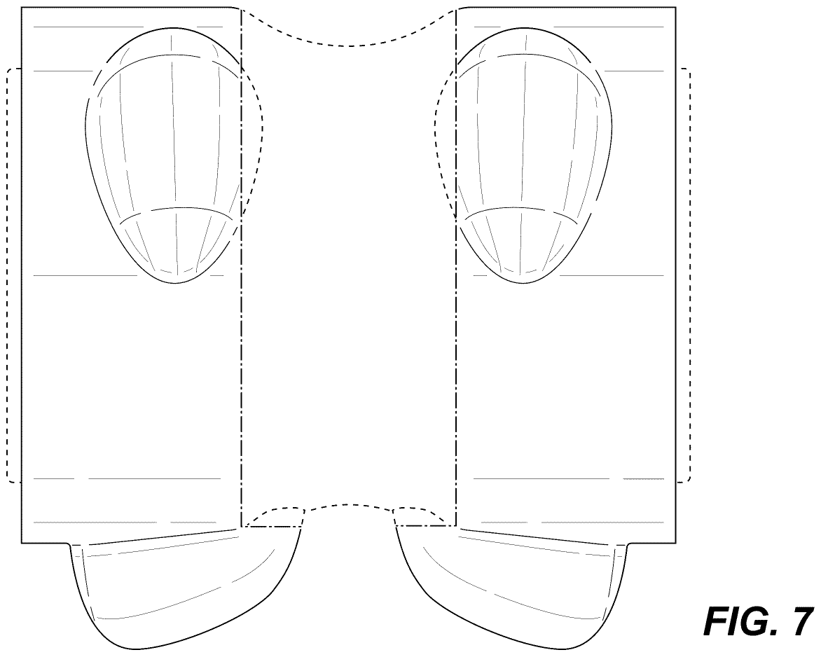

FIG. 7 is a top view thereof;

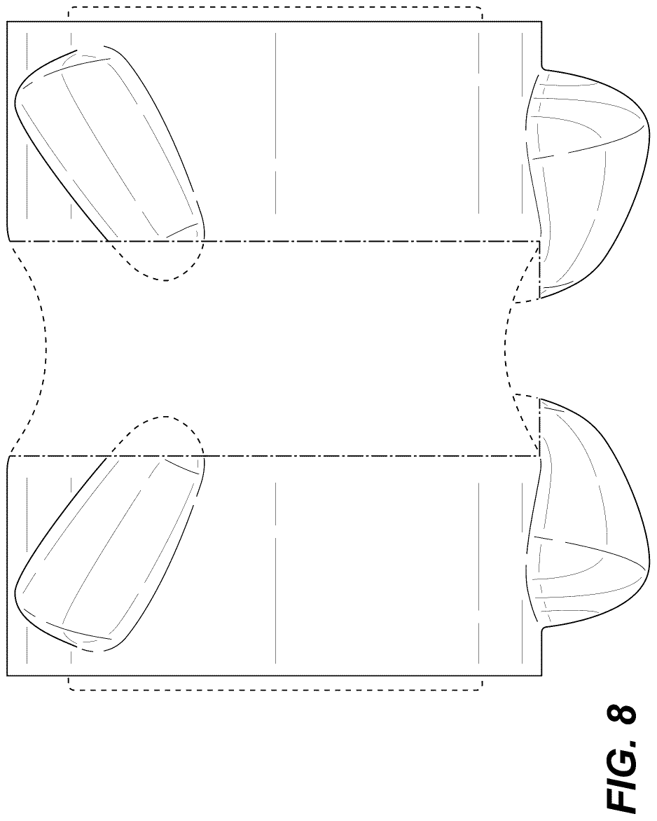

FIG. 8 is a bottom view thereof;

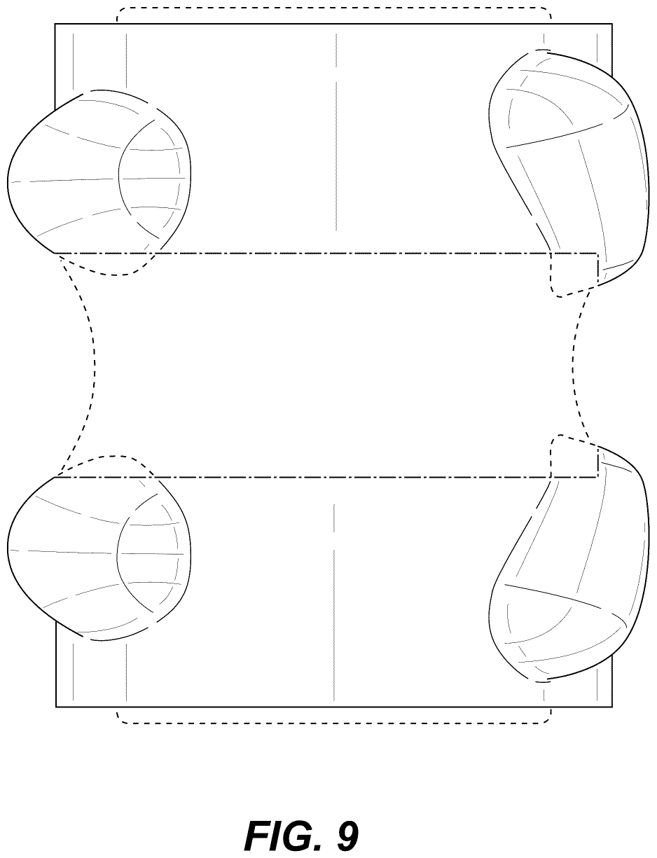

FIG. 9 is a back view thereof; and

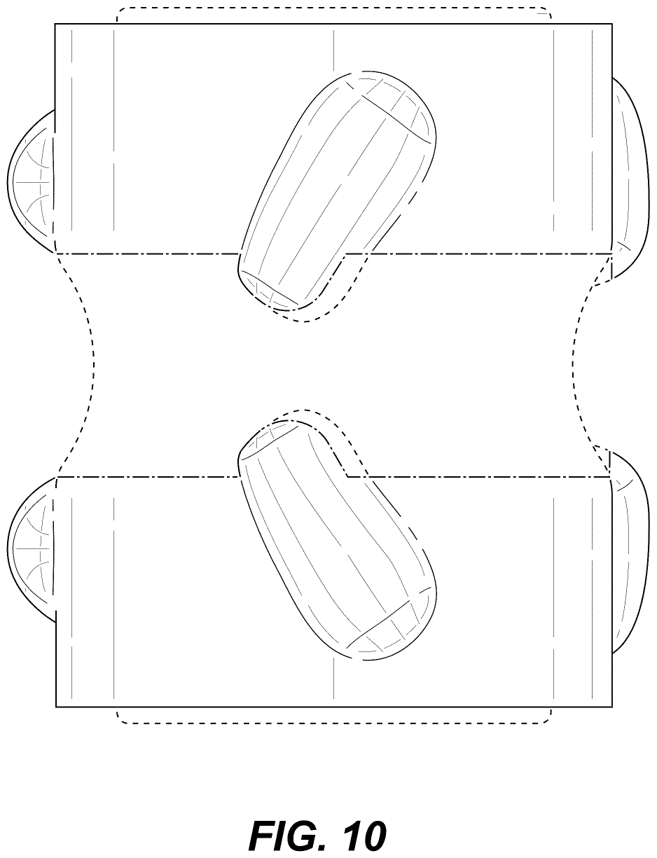

FIG. 10 is a front view thereof.

The dashed broken lines depict portions of the massage device that form no part of the claimed design. The dot-dashed broken lines represent boundaries of the claimed design and form no part of the claimed design.

The Applicant reserves the right to: 1) convert some or all of the broken lines to solid lines; and/or 2) convert selected solid lines to broken lines during the course of prosecution and/or in one or more continuation applications, since the figures convey that the inventors had possession of the solid line features and the broken line features as of the date of filing.

We claim:

1. The ornamental design for a massage device, as shown and described.
